(19) United States
(12) Patent Application Publication
(10) Pub. No.: US 2011/0137678 A1
(43) Pub. Date: Jun. 9, 2011

(54) SYSTEM AND METHOD FOR A STRUCTURED WORKOUT

(76) Inventor: MICHAEL C. WILLIAMS, Santa Barbara, CA (US)

(21) Appl. No.: 12/631,690

(22) Filed: Dec. 4, 2009

(51) Int. Cl. G06Q 50/00; G06F 3/048

(52) U.S. Cl. 705/3; 715/772

(57) ABSTRACT

The present invention provides a health and fitness system, comprising: means for creating or receiving a structured workout; means for generating a graphical representation of the structured workout; means for displaying the graphical representation on a smartphone; means for retrieving health and fitness data from health and fitness sensors or devices; means for displaying the health and fitness data on the graphical representation; means for storing the health and fitness data on the smartphone; and means for sharing the health and fitness data with a remote computing device or database on a server.

### FIELD OF THE INVENTION

The present invention relates generally to health and fitness, and more particularly, some embodiments relate to a health and fitness system that assists in structuring workouts.

### DESCRIPTION OF THE RELATED ART

Advancements in technology have changed the way people approach health and fitness. Over time, useful tools and devices have been developed that provide useful information in attaining and maintaining health and fitness goals. In addition to tracking one's goals, various tools and devices provide real-time information on performance, gauge one's performance to others, and offer tips and suggestions in one's diet and exercise routines. Tools and devices such as heart rate monitors, pace monitors or pedometers, cycling computers, glucose meters, weight scales, blood pressure monitors, physical training machines integrated with sensors, and other health and fitness sensor devices are commonplace in the world of fitness.

Workout routines are an essential part of meeting one's health and fitness goals. A workout routine is a defined schedule of workout sessions often designed by the exerciser, a fitness trainer, or a medical care professional to meet a specific health or fitness goal. For example, one who desires to lose weight may design a workout routine for herself that emphasizes the amount of calories burned. From a general perspective, each workout session in a workout routine contains a structured workout, which provides a list of exercises to be performed within a given workout session, and instructions on how those exercise should be performed. Often times, the structured workout for each session provides such details as what exercises should be performed in the session, the sequence in which exercises should be performed, the manner in which an exercise should be performed, and the time duration spent performing each exercise. For instance, a structured workout comprising of cycling and running, may be structured on intervals for performing each exercise within a specific time period and in a manner which reaches a target heart rate.

In assistance of meeting the objectives of a structured workout, some of today's health and fitness tools and devices provide for designing and tracking workout routines. Depending on the tool or device, the user could enter a custom workout routine into the tool or device or, a fitness trainer or medical professional could send a workout routine to the tool or device. The tool or device would then inform the user as to which workout routine or workout session should be performed at a given time or day.

Unfortunately, the workout routines provided by the tools and devices severely lack integration with the actual workouts performed by the user. For example, in order for the user to follow the details of a workout routine or workout session, the routine or session would need to be e-mailed and printed out so that it can be along during the workout.

### BRIEF SUMMARY OF EMBODIMENTS OF THE INVENTION

According to various embodiments of the invention, systems and methods are provided that assist in using and tracking a structured workout during a workout session.

According to one embodiment of the invention, a health and fitness system is provided, comprising: means for creating or receiving a structured workout; means for generating a graphical representation of the structured workout; means for displaying the graphical representation on a smartphone; means for retrieving health and fitness data from a health and fitness sensor or device; means for displaying the health and fitness data on the graphical representation; means for storing the health and fitness data on the smartphone; and means for sharing the health and fitness data with a remote computing device.

Various embodiments may display the health and fitness data on the graphical representation with color indicators that represent user progress based on the health and fitness data and the structured workout. Optionally, embodiments may display the health and fitness data as a trend line on the graphical representation. Where the health and fitness data is displayed as a trend line, the position of the trend line on the graphical representation may be based on how the structured workout is depicted as the graphical representation. Additionally, where the health and fitness data is displayed as a trend line, the trend line may scroll across the graphical representation as time elapses.

In some embodiments, wherein the structured workout is created on the health and fitness system or is received by the health and fitness system from an external source. In particular embodiments, the external source is a fitness trainer website, a medical website or medical practice management software. In additional embodiments, the remote computing device with which the health and fitness data is shared may be a computing device on the Internet.

According to further embodiments, various systems, methods, and operations described above are implemented using a computer. For example, some embodiments provide for a computer program product comprising a computer useable medium having computer program code embodied therein configured to cause a computing device to operate in accordance with aspects of the invention as described herein.

Other features and aspects of the invention will become apparent from the following detailed description, taken in conjunction with the accompanying drawings, which illustrate, by way of example, the features in accordance with embodiments of the invention. The summary is not intended to limit the scope of the invention, which is defined solely by the claims attached hereto.

### BRIEF DESCRIPTION OF THE DRAWINGS

The present invention, in accordance with one or more various embodiments, is described in detail with reference to the following figures. The drawings are provided for purposes of illustration only and merely depict typical or example embodiments of the invention. These drawings are provided to facilitate the reader's understanding of the invention and shall not be considered limiting of the breadth, scope, or applicability of the invention. It should be noted that for clarity and ease of illustration these drawings are not necessarily made to scale.

FIG. 1 is a diagram illustrating an example system of health and fitness on which an embodiment of the invention can operate.

FIG. 2 is a diagram illustrating an example health and fitness system in accordance with an embodiment of the invention.

FIG. 3 is a diagram of an example graphical representation in accordance with an embodiment of the invention.

FIG. 4 is a flowchart of an example method in accordance with an embodiment of the invention.

FIG. 5 is a diagram illustrating an example computing module for implementing various embodiments of the invention.

The figures are not intended to be exhaustive or to limit the invention to the precise form disclosed. It should be understood that the invention can be practiced with modification and alteration, and that the invention be limited only by the claims and the equivalents thereof.

### DETAILED DESCRIPTION OF THE EMBODIMENTS OF THE INVENTION

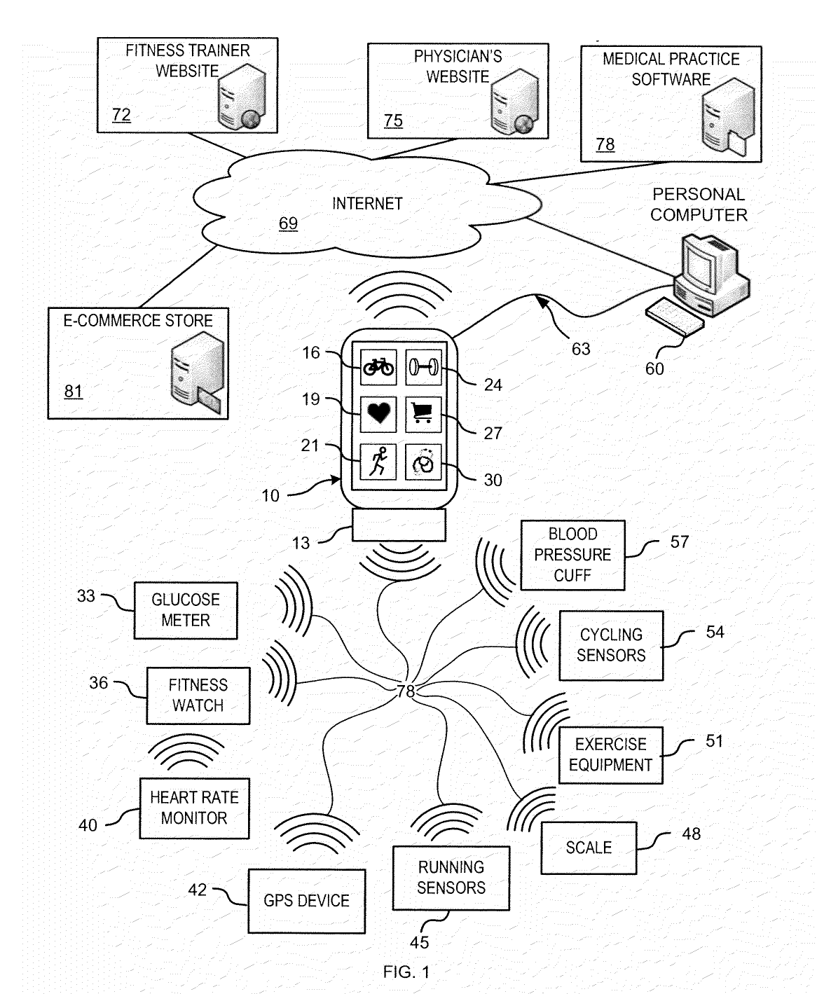

The present invention is directed toward a system and method for using and tracking a structured workout during a workout session. Before describing the invention in detail, it is useful to describe an example system with which an embodiment of the invention can be implemented. One such example is illustrated in FIG. 1, which depicts an example health and fitness system in which certain embodiments of the invention can operate or be integrated.

Referring now to FIG. 1, illustrated is a mobile computing device 10 equipped with a communications interface 13 that allows the device 10 to communicate with various health devices (33 through 57). In the illustrated embodiment, the device 10 is operating a health and fitness system. This system may also be referred to herein as a health and fitness ecosystem. Such an ecosystem is capable of integrating multiple health and fitness applications, and retrieving, storing and managing health and fitness data.

The mobile computing device 10 may be equipped with a communications interface 13 that allows the device 10 to communicate with various health monitoring devices. Additional communication interfaces (not shown) allow the device 10 to communicate with an external computer network, such as the Internet 69. Examples of a mobile computing device may comprise a mobile phone, such as a smartphone, or a PDA, that has a data connection to the Internet 69 and the ability to load and execute computer programs via an operating system. For example, computing device 10 may comprise a smartphone running an operating system and may be programmed with a health and fitness system application that allows it to communicate with the health monitoring devices (33 through 57) and allows health and fitness data collected from the health monitoring devices to be uploaded or synchronized to an external source, such as a website.

It should be noted that different health monitoring devices may be configured to communicate according to various protocols. For example, a cycling computer might be configured to wirelessly communicate according to the ANT+ protocol, while a GPS device might be configured to wirelessly communicate according to the Bluetooth protocol. Accordingly, the communications module 76 may be configured to communicate according to a plurality of different communications protocols to provide the obtained data to the mobile device 75.

In the illustrated example, the health and fitness system operating on device 10 comprises applications that help store, track and manage data provided by specific types of fitness activities. Here the applications are a cycling application 16, a weight training application 24, a cardio application 19, and a running application 21. Other applications relating to specific fitness activities could include without limitation a yoga application, a hiking application, a Spinning® application, a pilates application, a rowing application, and a walking application.

The illustrated system further comprises a health and fitness store 27, which allows a user to purchase health and fitness equipment, such as heart monitoring sensors, or health or fitness content such as a workout routine. Additionally, the system comprises a medical application 30, which can provide the user with health and medical information or advice. After reading the description provided herein, it will be apparent to one of ordinary skill in the art that a variety of applications relating to health and fitness could operate on a health and fitness systems in accordance with the invention. Additionally, depending on the embodiment, the application may retrieve and store information locally on the mobile device 10, or on a remote computing device connected to the mobile computing device 10 through a network connection. For example, the health and fitness store 27 may function by interfacing with a health and fitness store 81 via the Internet 69.

Through the illustrated system, a user may have access to a variety of health monitoring devices. For example, an athlete such as a runner may be equipped with a variety of data collecting devices during an exercise period, such as a running sensor 45, a GPS device 42, a heart rate monitor 40, and a fitness watch 39. Various devices may be configured to temporarily store data during the exercise period and then provide the system access to this data at a later point in time. For example, GPS device 42 may be configured to store a route taken by a runner during a run, and then to provide that route to the health fitness system at a later point in time. Furthermore, some health monitoring devices may be pre-configured to interoperate with each other before ultimate collection by the health and fitness system. For example, a fitness watch 36 may be configured to receive and collect data during an exercise period from other health monitoring devices, such as heart rate monitor 40.

Other health and fitness devices that can provide the system with data include glucose meter 33 and blood pressure cuff 57, both of which provide readings on body vitals, and a scale 48, which can provide the system with a user's weight. Additional exercise equipment 51 may include sensors that supply health and information data to the illustrated system.

The illustrated system is further configured to interface with a fitness trainer website 75, which provides the user of the mobile device 10 with personal fitness training via the health and fitness system, and a physician's websites 75 through which the mobile device 10 may provide health and fitness information to the user's physician in almost real-time. Optionally, the system may be configured to interface with the medical practice software 78 providing an alternative means for presenting health and fitness information to the user's physician. The system may synchronize or upload health and system data with the user's personal computer 60, which may be facilitated through a direct connection 63 with the personal computer or through an Internet connection. The direct connection 63 may be a wired or wireless connection between the personal computer 60 and the mobile device 10.

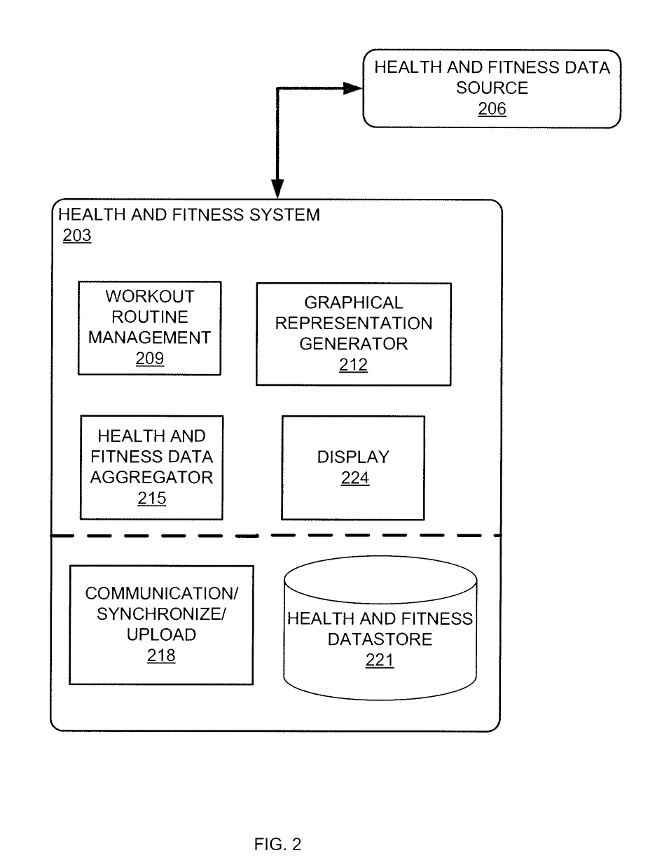

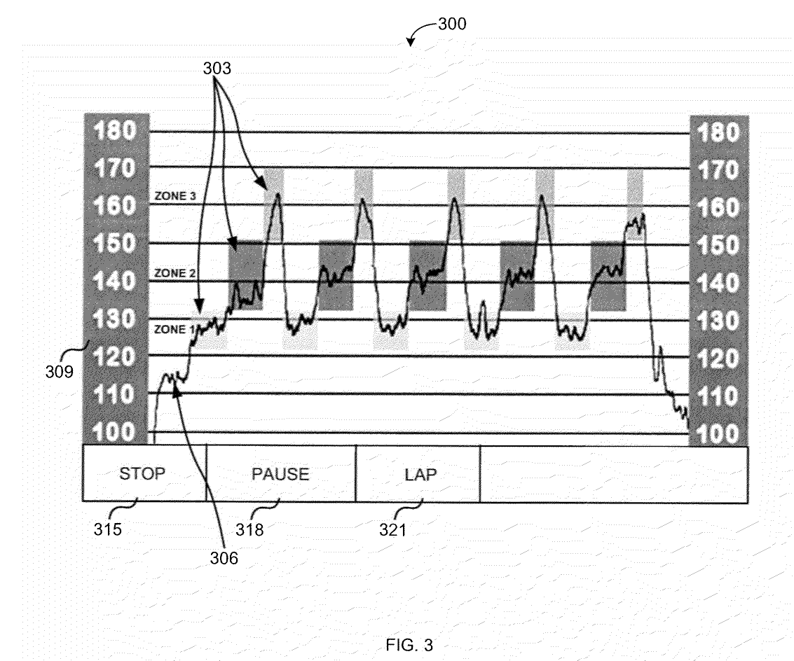

FIG. 2 is a diagram illustrating an example health and fitness system 203 in accordance with an embodiment of the invention. As illustrated, the system 203 comprises various components that facilitate creating or receiving a structured workout, generating a graphical representation of the structured workout, displaying the graphical representation on a computing device, retrieving health and fitness data from a health and fitness data source (e.g., health and fitness sensor or device), displaying the health and fitness data on the graphical representation, storing the health and fitness data on the computing device, and sharing the health and fitness data with a remote computing device. Depending on the embodiment, the computing device may be a mobile device, such as a smartphone or a personal digital assistant (PDA). Specifically, workout routine management 209 enables creation of a workout routine or workout session by a user. Additionally, management 209 can also receive a workout routine or workout session (i.e., structured workout) from an external source, such as a fitness trainer website, a medical website, or medical practice management software. Graphical representation generator 212 converts the structured workout into a graphical representation, that can be displayed by display component 224 onto a computing device. An example of such a graphical representation is illustrated in FIG. 3, which will be later discussed in further detail as FIG. 2 is discussed. The graphical representation 300 of FIG. 3 specifically depicts a structured cardio vascular workout, with the vertical indicators 309 indicating heart rate per minute. Also depicted are optional graphical user interface buttons 315-321, which allow a user to stop the workout 315, pause the workout 318, or start a new lap time 321 in the workout.

Continuing with FIG. 2, the health and fitness data aggregator 215 retrieves and gathers health and fitness data from one or more health and fitness data sources 206. In some embodiments, the health and fitness data are retrieved and gathered from a user performing the structured workout represented by the graphical representation, often at a real time or near-real time rate. These data sources may include, but are not limited to, sensors and devices such as a heart rate monitor, a weight scale, a blood pressure monitor, a glucose meter, a cycling sensor, a cycling computer, a rowing sensor, a rowing computer, a treadmill sensor, a treadmill computer, an elliptical trainer sensor, an elliptical trainer computer, a global-positioning system device, a running sensor, a pedometer, a fitness watch. and a mobile device configured to interact with a health monitoring device. In some embodiments, the data source may also be a remote computing device accessible over a network such as the Internet.

Once retrieved, the health and fitness data can be displayed on the graphical representation by display 224 such that it details the user's health and fitness progress in comparison to the objectives of the structured workout represented by the graphical representation. For example, in some embodiments, the health and fitness data is displayed on the graphical representation with color indicators, such as shading, can be used to represent user progress based on the health and fitness data retrieved. In another embodiment, the health and fitness data is displayed as a trend line on the graphical representation. FIG. 3 depicts such a trend line 306, where the position of the trend line determines what the heart rate is at a given time during the workout. As the workout progresses (i.e., time elapses during the workout), the trend line scrolls across the structured workout graphical representation 300. FIG. 3 further depicts shading indicators 303 that show which target heart zones 1-3 (i.e., zone 1, zone 2, zone 3) the trend line 306 is meeting at a given time.

Continuing with FIG. 2, the system 203 also comprises a communication, synchronization, and upload component 218 which allows the system 203 to share the health and fitness data retrieved with a remote computing device, such as a server or desktop computer on the Internet. Depending on the embodiment, the system 203 may share the health and fitness data retrieved by the aggregator 215, share the structured workout on which the health and fitness data was collected, or share the health and fitness data retrieved in comparison to the structured workout. Additionally, system 203 can store in the health and fitness datastore 221 the health and fitness data retrieved during the performance of the structured workout.

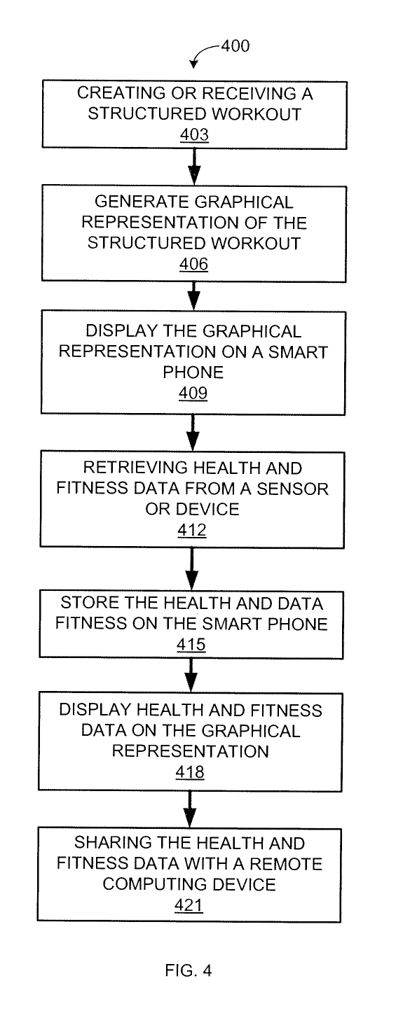

FIG. 4 is a flowchart of an example method 400 in accordance with one embodiment of the invention. The method begins with operation 403, where a structured workout (e.g., workout route, or workout session) is either created or received, and is followed by operation 406, where a graphical representation of this structured workout is generated. At operation 409, the graphical representation is displayed on a computing device, such as smartphone or PDA. At operation 412, method 400 retrieves health and fitness data from an external source, such as a health and fitness sensor or device. Typically, this data is retrieved and gathered at or near real time as the structured workout being displayed is performed by the user. The data retrieved and fathered is stored at on the computing device at operation 415, and then displayed on the graphical representation of the structured workout at operation 418. Method 400 concludes at operation 421, with the sharing of the health and fitness data with a remote computing device.

As used herein, the term set may refer to any collection of elements, whether finite or infinite. The term subset may refer to any collection of elements, wherein the elements are taken from a parent set; a subset may be the entire parent set. The term proper subset refers to a subset containing fewer elements than the parent set. The term sequence may refer to an ordered set or subset. The terms less than, less than or equal to, greater than, and greater than or equal to, may be used herein to describe the relations between various objects or members of ordered sets or sequences; these terms will be understood to refer to any appropriate ordering relation applicable to the objects being ordered.

The term tool can be used to refer to any apparatus configured to perform a recited function. For example, tools can include a collection of one or more modules and can also be comprised of hardware, software or a combination thereof. Thus, for example, a tool can be a collection of one or more software modules, hardware modules, software/hardware modules or any combination or permutation thereof. As another example, a tool can be a computing device or other appliance on which software runs or in which hardware is implemented.

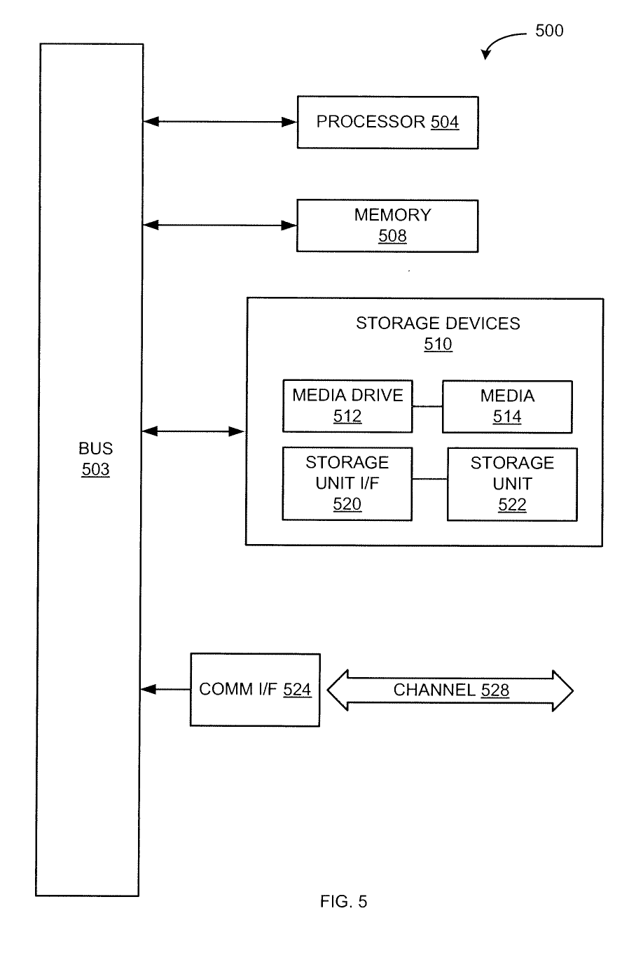

As used herein, the term module might describe a given unit of functionality that can be performed in accordance with one or more embodiments of the present invention. As used herein, a module might be implemented utilizing any form of hardware, software, or a combination thereof. For example, one or more processors, controllers, ASICs, PLAs, PALs, CPLDs, FPGAs, logical components, software routines or other mechanisms might be implemented to make up a module. In implementation, the various modules described herein might be implemented as discrete modules or the functions and features described can be shared in part or in total among one or more modules. In other words, as would be apparent to one of ordinary skill in the art after reading this description, the various features and functionality described herein may be implemented in any given application and can be implemented in one or more separate or shared modules in various combinations and permutations. Even though various features or elements of functionality may be individually described or claimed as separate modules, one of ordinary skill in the art will understand that these features and functionality can be shared among one or more common software and hardware elements, and such description shall not require or imply that separate hardware or software components are used to implement such features or functionality.

Where components or modules of the invention are implemented in whole or in part using software, in one embodiment, these software elements can be implemented to operate with a computing or processing module capable of carrying out the functionality described with respect thereto. One such example computing module is shown in FIG. 5. Various embodiments are described in terms of this example-computing module 500. After reading this description, it will become apparent to a person skilled in the relevant art how to implement the invention using other computing modules or architectures.

Referring now to FIG. 5, computing module 500 may represent, for example, computing or processing capabilities found within desktop, laptop and notebook computers; hand-held computing devices (PDA's, smartphones, cell phones, palmtops, etc.); mainframes, supercomputers, workstations or servers; or any other type of special-purpose or general-purpose computing devices as may be desirable or appropriate for a given application or environment. Computing module 500 might also represent computing capabilities embedded within or otherwise available to a given device. For example, a computing module might be found in other electronic devices such as, for example, digital cameras, navigation systems, cellular telephones, portable computing devices, modems, routers, WAPs, terminals and other electronic devices that might include some form of processing capability.

Computing module 500 might include, for example, one or more processors, controllers, control modules, or other processing devices, such as a processor 504. Processor 504 might be implemented using a general-purpose or special-purpose processing engine such as, for example, a microprocessor, controller, or other control logic. In the illustrated example, processor 504 is connected to a bus 503, although any communication medium can be used to facilitate interaction with other components of computing module 500 or to communicate externally.

Computing module 500 might also include one or more memory modules, simply referred to herein as main memory 508. For example, preferably random access memory (RAM) or other dynamic memory, might be used for storing information and instructions to be executed by processor 504. Main memory 508 might also be used for storing temporary variables or other intermediate information during execution of instructions to be executed by processor 504. Computing module 500 might likewise include a read only memory (“ROM”) or other static storage device coupled to bus 503 for storing static information and instructions for processor 504.

The computing module 500 might also include one or more various forms of information storage mechanism 510, which might include, for example, a media drive 512 and a storage unit interface 520. The media drive 512 might include a drive or other mechanism to support fixed or removable storage media 514. For example, a hard disk drive, a floppy disk drive, a magnetic tape drive, an optical disk drive, a CD or DVD drive (R or RW), or other removable or fixed media drive might be provided. Accordingly, storage media 514 might include, for example, a hard disk, a floppy disk, magnetic tape, cartridge, optical disk, a CD or DVD, or other fixed or removable medium that is read by, written to or accessed by media drive 512. As these examples illustrate, the storage media 514 can include a computer usable storage medium having stored therein computer software or data.

In alternative embodiments, information storage mechanism 510 might include other similar instrumentalities for allowing computer programs or other instructions or data to be loaded into computing module 500. Such instrumentalities might include, for example, a fixed or removable storage unit 522 and an interface 520. Examples of such storage units 522 and interfaces 520 can include a program cartridge and cartridge interface, a removable memory (for example, a flash memory or other removable memory module) and memory slot, a PCMCIA slot and card, and other fixed or removable storage units 522 and interfaces 520 that allow software and data to be transferred from the storage unit 522 to computing module 500.

Computing module 500 might also include a communications interface 524. Communications interface 524 might be used to allow software and data to be transferred between computing module 500 and external devices. Examples of communications interface 524 might include a modem or softmodem, a network interface (such as an Ethernet, network interface card, WiMedia, IEEE 802.XX or other interface), a communications port (such as for example, a USB port, IR port, RS232 port Bluetooth® interface, or other port), or other communications interface. Software and data transferred via communications interface 524 might typically be carried on signals, which can be electronic, electromagnetic (which includes optical) or other signals capable of being exchanged by a given communications interface 524. These signals might be provided to communications interface 524 via a channel 528. This channel 528 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to media such as, for example, memory 508, storage unit 520, media 514, and channel 528. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing module 500 to perform features or functions of the present invention as discussed herein.

While various embodiments of the present invention have been described above, it should be understood that they have been presented by way of example only, and not of limitation. Likewise, the various diagrams may depict an example architectural or other configuration for the invention, which is done to aid in understanding the features and functionality that can be included in the invention. The invention is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement the desired features of the present invention. Also, a multitude of different constituent module names other than those depicted herein can be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the invention is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the invention, whether or not such embodiments are described and whether or not such features are presented as being a part of a described embodiment. Thus, the breadth and scope of the present invention should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A health and fitness system, comprising:
means for creating or receiving a structured workout;
means for generating a graphical representation of the structured workout;
means for displaying the graphical representation on a smartphone;
means for retrieving health and fitness data from health and fitness sensors or devices;
means for displaying the health and fitness data on the graphical representation;
means for storing the health and fitness data on the smartphone; and
means for sharing the health and fitness data with a remote computing device. or database on a server

2. The health and fitness system of claim 1, wherein the health and fitness data is displayed on the graphical representation with color indicators that represent user progress based on the health and fitness data and the structured workout.

3. The health and fitness system of claim 1, wherein the health and fitness data is displayed on the graphical representation as a trend line.

4. The health and fitness system of claim 2, wherein a position of the trend line on the graphical representation is based on how the structured workout is depicted as the graphical representation.

5. The health and fitness system of claim 2, wherein the trend line scrolls across the graphical representation as time elapses.

6. The health and fitness system of claim 1, wherein the structured workout is created on the health and fitness system or is received by the health and fitness system from an external source.

7. The health and fitness system of claim 7, wherein the external source is a fitness trainer website, a medical website, or medical practice management software.

8. The health and fitness system of claim 1, wherein the remote computing device is on the Internet.

9. The health and fitness system of claim 1, wherein the health and fitness sensor or device is a heart rate monitor, a weight scale, a blood pressure monitor, a glucose meter, a cycling sensor, a cycling computer, a rowing sensor, a rowing computer, a treadmill sensor, a treadmill computer, an elliptical trainer sensor, an elliptical trainer computer, a global-positioning system device, a running sensor, a pedometer, a fitness watch or a mobile device configured to interact with a health monitoring device.

10. A computer program product comprising a computer useable medium having computer program code embodied therein configured to cause a computing device to:
create or receive a structured workout;
generate a graphical representation of the structured workout;
display the graphical representation on a smartphone;
retrieve health and fitness data from a health and fitness sensor or device;
display the health and fitness data on the graphical representation; and
store the health and fitness data on the smartphone.

11. The computer program product of claim 10, wherein the computer program code is further configured to cause the computing device to:
share the health and fitness data with a remote computing device.

12. The computer program product of claim 10, wherein the health and fitness data is displayed on the graphical representation with color indicators that represent progress based on the health and fitness data and the structured workout.

13. The computer program product of claim 10, wherein the health and fitness data is displayed on the graphical representation as a trend line.

14. The computer program product of claim 13, wherein a position of the trend line on the graphical representation is based on how the structured workout is depicted as the graphical representation.

15. The computer program product of claim 13, wherein the trend line scrolls across the graphical representation as time elapses.

16. The computer program product of claim 10, wherein the structured workout is created on the health and fitness system or is received by the health and fitness system from an external source.

17. The computer program product of claim 16, wherein the external source is a fitness trainer website, a medical website, or medical practice management software.

18. The computer program product of claim 10, wherein the remote computing device is on the Internet.

19. The computer program product of claim 10, wherein the health and fitness sensor or device is a heart rate monitor, a blood pressure monitor, a glucose meter, a cycling sensor, a cycling computer, a rowing sensor, a rowing computer, a treadmill sensor, a treadmill computer, an elliptical trainer sensor, an elliptical trainer computer, a global-positioning system device, a running sensor, a pedometer, a fitness watch. or a mobile device configured to interact with a health monitoring device.
